(19) United States
(12) Patent Application Publication
(10) Pub. No.: US 2009/0307872 A1
(43) Pub. Date: Dec. 17, 2009

(54) PIVOT STRUCTURE

(75) Inventors: Sheng-Hsiung YANG, Hukou Township (TW); Mu-Kun HSUEH, Kaohsiung City (TW)

Correspondence Address: Workman Nydegger;1000 Eagle Gate Tower, 60 East South Temple, Salt Lake City, UT, 84111, US

(73) Assignee: SMARTANT TELECOM CO., LTD., Jhudong Township (TW)

(21) Appl. No.: 12/137,062

(22) Filed: Jun. 11, 2008

(51) Int. Cl. E05D 5/14

(52) U.S. Cl. 16/272

(57) ABSTRACT

A pivot structure is used to pivotally connect a first object to a second object includes a pivot hole and a pivot portion. The pivot hole is disposed at the second object, while the pivot portion is disposed at the first object. The pivot portion has a discontinuous ring with an outside diameter lager than an aperture of the pivot hole. The discontinuous ring can be squeezed to be deformed and be inserted into the pivot hole, such that the discontinuous ring tightly bears against the pivot hole to maintain an included angle between the first object and the second object at any time, thereby a user can steplessly adjust the included angle of the two objects.

### BACKGROUND OF THE INVENTION

1. Field of the Invention

The present invention relates to a pivot structure, in particular, to a stepless pivot structure applied in a desktop antenna included a directional plate and an antenna base, in which the directional plate is rotated with respect to the antenna base and maintains a certain direction at any time.

2. Related Art

In the current working environment with an information electronization trend, every staff in the office uses a desktop computer or a notebook computer during daily work. In order to effectively connect these computers for transferring or exchanging various messages and data between the staff, most companies or enterprises are equipped with signal cables and a server to construct a required internal network. However, the actual routing and construction of a wired network has a high cost. Furthermore, as for the rented office, the construction and wiring of a wired network tend to cause damages to the building, and the star-studded complicated circuits bring lots of troubles to the management and maintenance. Thus, currently, many companies or enterprises have used a wireless network to build their internal network, and accordingly, each computer should be equipped with an antenna device for receiving the signals of wireless network, thereby such an antenna device has been increasingly prevailing.

As for the antenna device for receiving the signals of wireless network in offices, a small desktop antenna with an adjustable signal-receiving angle is most commonly used. Such a desktop antenna generally includes a base and a directional plate pivotally connected on the base. A densely-distributed antenna array is arranged in the directional plate, and since the directional plate can be swung freely, the direction and tilt angle of the directional plate can be adjusted by the user arbitrarily. Thus, the directional plate may point to a signal-sending part (e.g., a wireless server, a wireless router, and the like) as possible, which is helpful for the directional plate to transmit and receive the wireless network signals, thereby increasing the efficiency for the antenna device to receive radio frequency (RF) signals. As shown in FIG. 1, it shows a common desktop antenna and a pivot structure thereof, wherein the desktop antenna comprises a base 10 and a directional plate 11. The directional plate 11 is pivotally connected to one side of the base 10 through a revolving shaft 12, such that the directional plate 11 can be rotated with respect to the base 10 to change an included angle there-between, which enables the user to adjust the direction of the directional plate 11. Such a similar pivot structure has been widely used, but the pivot element thereof occupies an excessive large volume, which is not suitable for small electronic products with a narrow inner space. On the other hand, in the design of such a pivot portion for the desktop antenna, how to configure the signal line between the directional plate 11 and the base 10 is not considered, and once the directional plate 11 is adjusted to a proper signal receiving angle, whether the directional plate 11 can be maintained at the signal receiving angle at any time is not considered as well.

In order to maintain the directional plate and the base at an adjusted angle, and to solve the routing problem of the signal line between the directional plate and the base, a antenna and a step pivot structure thereof shown in FIG. 2 has been proposed. The antenna comprises a base 10 and a directional plate 11. Two rotary disks 20 are disposed at one side of the directional plate 11, and two pivot slots 21 matching with the rotary disks 20 are formed at one side of the base 10. Each rotary disk 20 includes an axle hole 22 and several fixing slots 23. Each pivot slot 21 has ribs inserted to the axle hole 22 and clipped with each fixing slot 23 respectively, such that the directional plate 11 is not only rotated with respect to the base 10, but also maintained at the angle of the fixing slot 23 with respect to the base 10. Furthermore, an elongate slot 24 is open in the directional plate 11 for routing the signal lines, such that the signal lines are extended to the base 10 from the directional plate 11. Such a step pivot structure provides an efficacy of fixing the angle of the directional plate 11, but it is limited to a predetermined angle of the fixing slot 23, and cannot be fine adjusted and fixed at any angle randomly, such that the angles for the directional plate 11 to receive signals are rather limited. The signal transmission lines are exposed out of the directional plate 11 and the base 10, and tend to be damaged due to pulling and abrasion when the directional plate 11 is rotated with respect to the base 10.

### SUMMARY OF THE INVENTION

The adjustment angle of the pivot structure in the desktop antenna is rather limited, and the routing manner of signal lines is not desirable in the prior art. In view of this, the present invention is directed to a pivot structure applied in the desktop antenna, so as to solve the problem that the adjustment angle of the conventional pivot structure is rather limited, thereby providing a preferred routing manner for the signal lines.

To solve the aforementioned problems, the present invention provides a pivot structure, which includes a pivot hole, a pivot portion, and a main fin. The pivot structure is used to rotatably connect a first object to a second object, wherein the first object may substantially be, but not limited to, a directional plate of a desktop antenna in and the second object may substantially be, but not limited to, a base of the desktop antenna. The second object is provided with a bulge portion, and the above pivot hole and at least one positioning hole adjacent to the pivot hole are formed on the bulge portion. The pivot portion is disposed at the first object, and has a discontinuous ring corresponding to the pivot hole and a positioning rib adjacent to the discontinuous ring. An outside diameter of the discontinuous ring is larger than an aperture of the pivot hole. The discontinuous ring is squeezed to be deformed, inserted into the pivot hole, and pushes against the pivot hole outwards along a radial direction under a normal state, such that an outer peripheral surface of the discontinuous ring bears against an inner edge of the pivot hole. The positioning rib is dispose corresponding to the positioning hole of the bulge portion, and is against an outer edge of the pivot hole or inserts into the positioning hole. The main fin is also disposed at the first object and extends to form a sub fin corresponding to the positioning rib. The main fin is used to push against one side of the pivot portion, such that the other side of the pivot portion tightly contacts the outer edge of the pivot hole. The sub fin is used to push against one side of the positioning rib, such that the front end of the other side of the positioning rib tightly contacts the outer side of the pivot hole or tightly inserts into the positioning hole. Therefore, the static friction force generated on the contact surfaces between the discontinuous ring and the pivot hole, the pivot portion and the outer edge of the pivot hole, and the positioning rib and the outer edge of the pivot hole is sufficient for resisting the component force of the weight of the first object itself, thereby maintaining the included angle between the first object and the second object at any time, or maintaining the first object and the second object at a predetermined included angle of the positioning hole with respect to the second object. Furthermore, the pivot portion further includes a through hole. The through hole is disposed inside the inner peripheral surface of the discontinuous ring, and communicates with the pivot hole of the bulge portion, thereby communicating the inner space of the first object with that of the second object.

The efficacy of the present invention lies in that, the first object (the directional plate of the desktop antenna) is pivotally connected to the second object (the base of the desktop antenna) by the pivot structure of the present invention, such that the directional plate of the desktop antenna can not only be rotated with respect to the base, but also be maintained at an adjusted angle (direction) at any time, thereby increasing the convenience and performance of steplessly fine adjusting the desktop antenna. Therefore, the directional plate of the desktop antenna points towards the signal source more precisely, and the signal lines inside the directional plate are routed in the pivot hole and the through hole, such that the signal lines are concealed inside the desktop antenna, which are prevented from being damaged carelessly.

### BRIEF DESCRIPTION OF THE DRAWINGS

The present invention will become more fully understood from the detailed description given herein below for illustration only, which thus is not limitative of the present invention, and wherein:

FIG. 1 is a perspective exploded view of a pivot portion of a desktop antenna in the prior art;

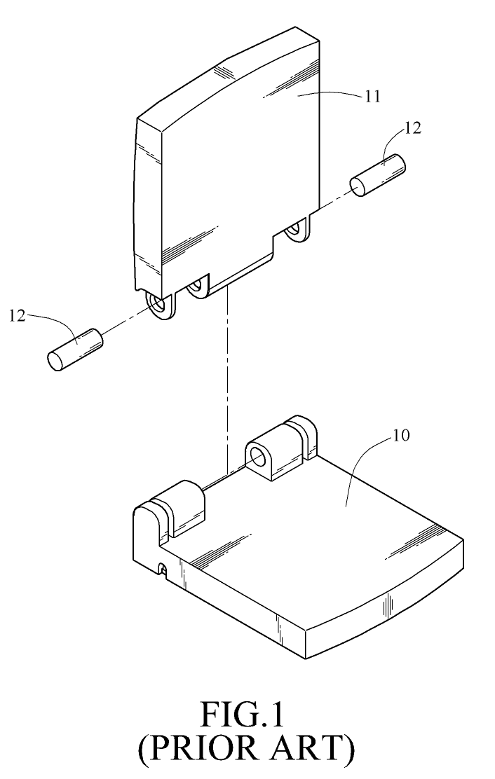

FIG. 2 is a perspective exploded view of a step pivot portion of the desktop antenna in the prior art;

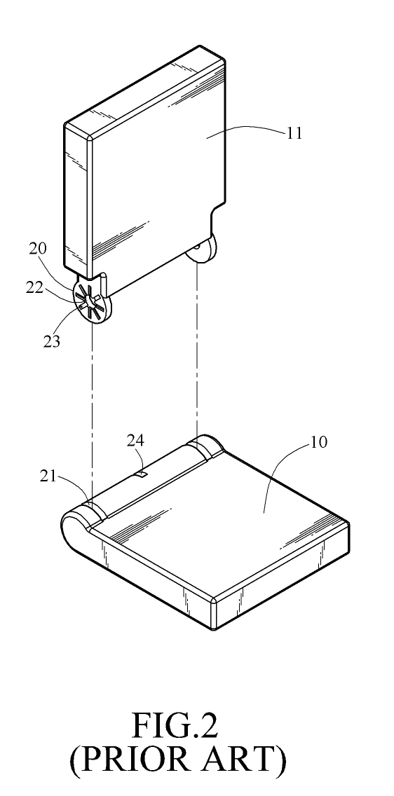

FIG. 3 is a perspective exploded view of a pivot structure according to the present invention;

FIG. 4 is a partially-enlarged schematic view of a pivot portion in the pivot structure according to the present invention;

FIG. 5 is an exploded view of the pivot portion in FIG. 4;

FIG. 6 is a partial schematic view of a front cover and a second object according to the present invention; and

FIG. 7 is a schematic perspective view of the pivot structure according to the present invention.

### DETAILED DESCRIPTION OF THE INVENTION

To make the object, construction, feature, and function of the present invention more comprehensible, the present invention is illustrated below through the embodiments as follows.

According to the present invention, the applications of the pivot structure include, but not limited to, small mechanisms or small electronic devices having one part being open or closed with respect to the other part, such as a clamshell mobile phone, a personal digital assistant (PDA), a desktop antenna, a clamshell clock, and the like. Through the pivot structure of the present invention, these mechanisms or devices may be maintained at an adjusted angle at any time, and brings convenience for stepless fine adjustment in use. However, only the desktop antenna is taken as a specific embodiment of the present invention in the following detailed descriptions.

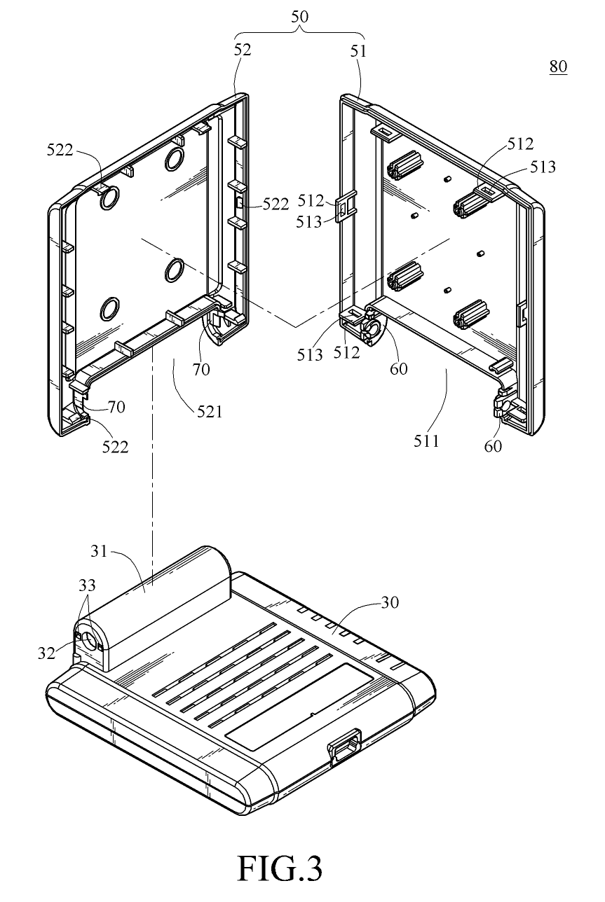

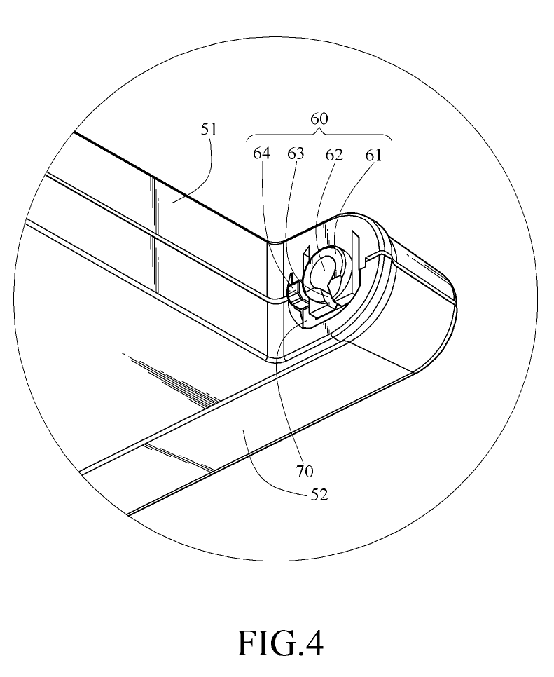

Referring to FIGS. 3 and 4, they show a pivot structure applied in a desktop antenna 80 according to the present invention. The pivot structure is used to rotatably connect a first object 50 to a second object 30, which is provided for the user to steplessly fine adjust an included angle between the first object 50 and the second object 30. This pivot structure is assembled between the second object 30 and the first object 50 in pairs, and includes a pivot hole 32, a pivot portion 60, and a main fin 70. The pivot portion 60 and the main fins 70 are both disposed at the first object 50, and the pivot hole 32 is disposed (open) at the second object 30, such that the pivot structure is a kind of stepless pivot structure.

The second object 30 is a hollow shell body, and constitutes a base of the desktop antenna 80 for carrying a main circuit board. The main circuit board within the second object 30 is electronically connected to a network card, a network chip, and other communication modules of a computer host, so as to provide the wireless signals received by the desktop antenna to the above computer host via the communication modules. A bulge portion 31 is extended at one side on the top of the second object 30, and the pivot hole 32 and two positioning holes 33. Each positioning hole 33 is disposed at the second object 30, adjacent to the pivot hole 32, and open in two end surfaces of the bulge portion 31 respectively. The pivot hole 32 is connected to the interior of the second object 30. The number of the positioning holes 33 is not limited herein, which may be increased or decreased depending on an actual requirement. For example, the predetermined included angles between the two positioning holes 33 and the second object 30 in the present invention are respectively 0 degree and 180 degrees, but other predetermined included angles such as 45 degrees and 90 degrees may also be set.

The first object 50 is a hollow shell body, which is assembled by a front cover 51 and a back cover 52 to constitute a directional plate of the desktop antenna 80. A densely-distributed antenna array is arranged within the first object 50 for receiving and transmitting RF signals, for example, receiving and transmitting signals of wireless network between a wireless server and the above computer host. The antenna array within the first object 50 is electronically connected to the main circuit board within the second object 30 through a signal line (not shown), such that the signals are transferred between the antenna array and the main circuit board, and then input to the computer host through the main circuit board, or output to the antenna array from the computer host for transmission. The front cover 51 and the back cover 52 are, but not limited to, made of an integrally molded material.

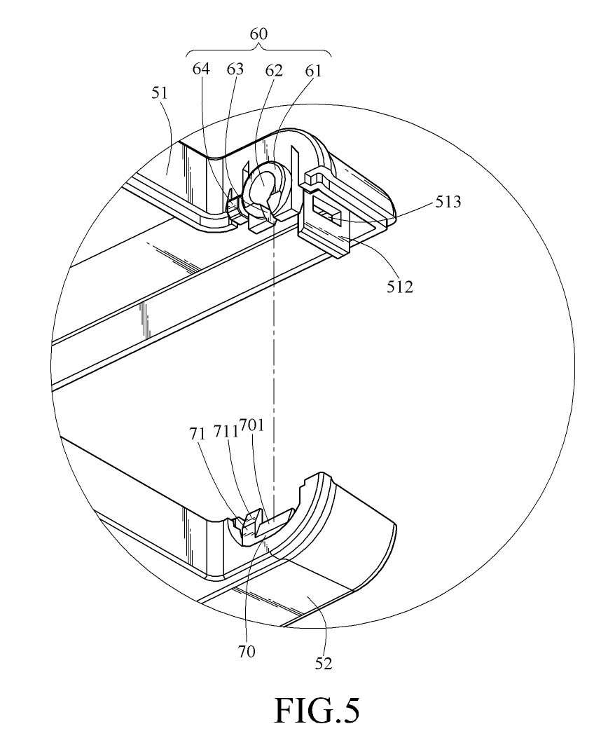

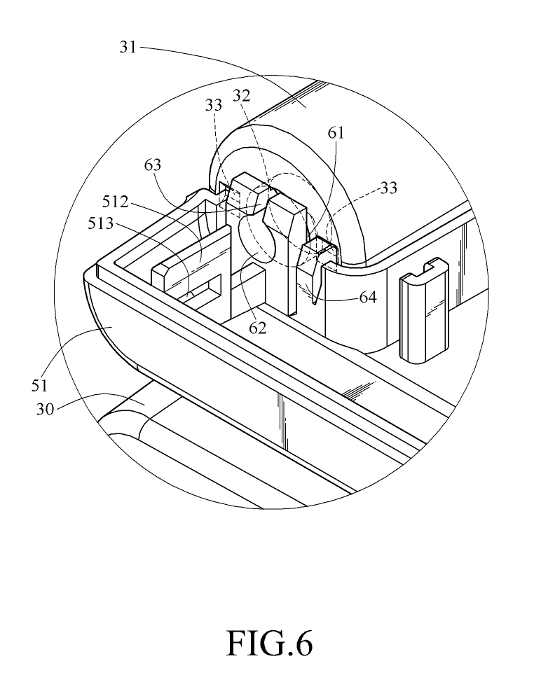

Referring to FIGS. 4, 5, and 6, a front recess 511 matching with the bulge portion 31 is formed and recessed inwards at one side of the front cover 51, and a plurality of buckling portions 512 is formed at the other side edges of the front cover 51. Each of the buckling portions 512 has a buckling hole 513. The pivot portion 60 is formed on the front cover 51, and respectively disposed at two sides of the front recess 511. Each pivot portion 60 includes a discontinuous ring 61, a through hole 62, a notch 63, and a positioning rib 64. The pivot portion 60 is made of an injection molded elastic material, such as, but not limited to, an injection molded plastic material.

Each discontinuous ring 61 is formed at one side of each pivot portion 60 and disposed corresponding to the pivot hole 32 at two sides of the bulge portion 31 respectively. The outside diameter of the discontinuous ring 61 is larger than the aperture of the pivot hole 32. Each through hole 62 is disposed (open) inside the inner peripheral surface of each discontinuous ring 61 for communicating the inner space of the first object 50 with the pivot hole 32, so as to communicate the inner space of the second object 30 with that of the first object 50. Therefore, the signal line of the first object 50 enters the second object 30 from the through hole 62 and the pivot hole 32. Each notch 63 is disposed (open) at two ends of the discontinuous ring for connecting to the through hole 62, so as to separate one discontinuous ring 61 and to provide a proper gap, such that two ends of the discontinuous ring 61 are opposite and separated from each other. Therefore, the discontinuous ring 61 may be squeezed to be elastically deformed to shrink its outside diameter, so as to be inserted into the pivot hole 32, thereby pushing against the pivot hole 32 outwards along a radial direction under a normal state. The discontinuous ring 61 has an outward tension along the radial direction, and the tension let the outer peripheral surface of the discontinuous ring 61 to bear tightly against the inner edge of the pivot hole 32, thereby maintaining the included angle between the first object 50 and the second object 30 at any time. Each positioning rib 64 is extended to the front recess 511 from the front cover 51 and is adjacent to the discontinuous ring 61. Each positioning rib 64 is disposed corresponding to the positioning holes 33 of the bulge portion 31 respectively. The front end of the positioning rib 64 is against the outer edge of the pivot hole 32 or inserts into each positioning hole 33 of the bulge portion 31 respectively.

A rear recess 521 matching with the bulge portion 31 and corresponding to the front recess 511 is disposed and recessed inwards at one side of the back cover 52, and a plurality of buckling hooks 522 corresponding to each buckling portion 512 is formed at the other side edges of the back cover 52. Each buckling hook 522 is buckled with the buckling hole 513 of each buckling portion 512, thereby assembling the back cover 52 with the front cover 51.

Each main fin 70 is formed on the back cover 52 and disposed at two sides of the rear recess 521 of the first object respectively. Each main fin 70 is extended to form a sub fin 71 corresponding to the positioning rib 64. The main fin 70 pushes against one side of the pivot portion 60, such that the other side of the pivot portion 60 (i.e., the outer side of the discontinuous ring 61) tightly contacts the outer edge of the pivot hole 32, so as to assist the discontinuous ring 61 to maintain the included angle between the first object 50 and the second object 30. The sub fin 71 pushes against one side of the positioning rib 64, such that the front end of the other side of the positioning rib 64 tightly contacts the outer side of the pivot hole 32 to assist the discontinuous ring 61 to maintain the included angle between the first object 50 and the second object 30. In other words, the sub fin 71 is bent to be deformed to tightly clip with the positioning hole 33 of the bulge portion 31, so as to maintain the first object 50 and the second object 30 at a predetermined included angle of the positioning hole 33 with respect to the second object 30. A guide chamfer 701 and a guide chamfer 711 are respectively formed at the front end of each main fin 70 and each sub fin 71. The guide chamfer 701 is used to guide the main fin 70 to slowly reach a correct position for pushing against the pivot portion 60 when assembling the front cover 51 with the back cover 52, and the guide chamfer 711 is used to guide the sub fin 71 to slowly reach a correct position for pushing against the positioning rib 64 when assembling the front cover 51 with the back cover 52, so as to prevent the main fin 70 and the sub fin 71 from directly crashing the pivot portion 60 and the positioning rib 64, thereby causing a structure damage there-between. The main fin 70 is made of an injection molded material, for example, an injection molded plastic material.

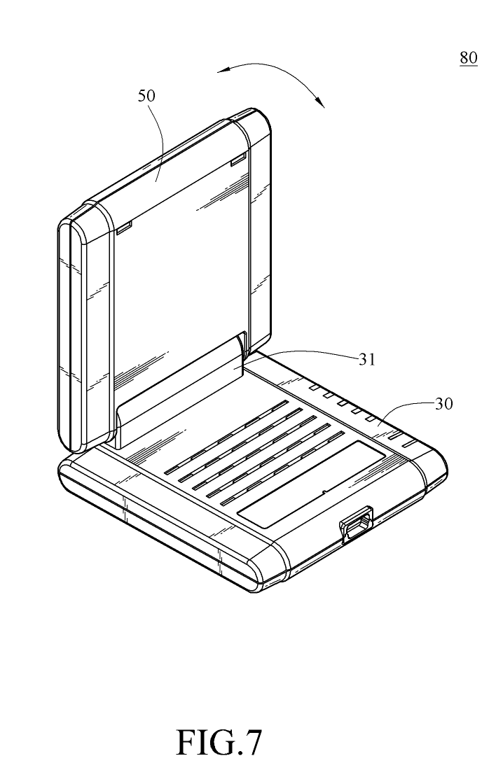

Referring to FIGS. 3 to 7, when the user wants to unfold and rotate the first object 50 with respect to the second object 30 (at this time, the user applies a force continuously, but the first object 50 does not move), a static friction resistance for resisting the force applied by the user is generated between the outer peripheral surface of the discontinuous ring 61 and the inner edge of the pivot hole 32, between one side of the pivot portion 60 (the edge of the discontinuous ring 61) and the edge of the pivot hole 32, and between the positioning rib 64 and the edge of the pivot hole 32 due to the interference or tight contact effects there-between, such that the first object 50 cannot move with respect to the second object 30 for a while. When the user continues to apply a force larger than the critical value of the static friction resistance, the first object 50 is rotated with respect to the second object 30. In other words, when the user does not apply a force to the first object 50, each contact surface also generates a static friction resistance for resisting a gravity effect under a pressure of the weight of the first object 50 itself, such that the first object 50 is maintained at an adjusted position under a normal state, and the included angle between the first object 50 and the second object 30 is maintained at any time, i.e., the direction of the first object 50 (the directional plate) is maintained at any time.

Furthermore, when the user unfolds and rotates the first object 50 into a state of almost completely closed (the predetermined included angle of the positioning hole 33 is 0 degree) or completely open (the predetermined included angle of the positioning hole 33 is 180 degrees), i.e., the positioning rib 64 of each pivot portion 60 begins to contact the corresponding positioning hole 33 of the bulge portion 31, each sub fin 71 of the main fin 70 pushes each positioning rib 64 to automatically enter the corresponding positioning hole 33, and drives the first object 50 into a completely closed position or a completely open position, which is convenient for the user to manipulate the desktop antenna 80. The above signal lines for electronically connecting the main circuit board and the antenna array may also be routed through the pivot hole 32 and the through hole 62, such that the signal lines may be more preferably routed, and may not be damaged due to pulling or abrasion when the first object 50 is rotated.

In the stepless pivot structure of the present invention, the first object 50 is pivotally connected to the pivot hole 32 of the second object 30 through the discontinuous ring 61 of the pivot portion 60 thereof, so that the first object 50 (the directional plate) of the desktop antenna 80 is not only rotated with respect to the second object 30, but also fixed at the adjusted angle at any time. Therefore, through the stepless pivot structure of the present invention, the user can conveniently and steplessly fine adjust the direction of the directional plate, and the directional plate of the desktop antenna 80 points to the signal source more precisely, thereby further increasing the efficiency of the directional plate in receiving and transmitting signals. The signal lines within the directional plate may be routed via the pivot hole 32 of the bulge portion 31 and the through hole 62 of the pivot portion 60, such that the signal lines are concealed inside the desktop antenna 80, thereby avoiding from being exposed and damaged, and enhancing the aesthetic sense for the appearance of the desktop antenna 80.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pivot structure, used to rotatably connect a first object to a second object, the pivot structure comprising:
a pivot hole, disposed at the second object; and
a pivot portion, disposed at the first object, and having a discontinuous ring corresponding to the pivot hole formed at one side thereof, wherein an outside diameter of the discontinuous ring is larger than an aperture of the pivot hole, and the discontinuous ring is be squeezed to be deformed and inserted into the pivot hole, such that an outer peripheral surface of the discontinuous ring tightly bears against an inner edge of the pivot hole, thereby maintaining an included angle between the first object and the second object at any time.

2. The pivot structure according to claim 1, wherein the pivot portion is made of an elastic material.

3. The pivot structure according to claim 2, wherein the pivot portion is made of an injection molded plastic material.

4. The pivot structure according to claim 1, wherein the pivot portion further comprises a through hole, disposed inside an inner peripheral surface of the discontinuous ring, for communicating with the pivot hole.

5. The pivot structure according to claim 4, wherein the pivot portion further comprises a notch, disposed between two ends of the discontinuous ring, for communicating with the through hole.

6. The pivot structure according to claim 1, further comprising at least one positioning hole disposed at the second object and adjacent to the pivot hole, wherein the pivot portion further comprises a positioning rib disposed corresponding to the positioning hole, and the positioning rib is against an outer edge of the pivot hole or insert into the positioning hole.

7. The pivot structure according to claim 6, further comprising a main fin disposed at the first object, and the main fin pushes against one side of the pivot portion, such that the other side of the pivot portion tightly contacts the outer edge of the pivot hole.

8. The pivot structure according to claim 7, wherein the main fin further comprises a sub fin disposed corresponding to the positioning rib, and the sub fin pushes against each of the positioning ribs to tightly contact the outer edge of the pivot hole or tightly insert into the positioning hole.
